(19) United States
(12) Patent Application Publication
(10) Pub. No.: US 2012/0038543 A1
(43) Pub. Date: Feb. 16, 2012

(54) Method and Apparatus to Support Miniature Image Displays

(76) Inventors: H. Lee MARTIN, Knoxville, TN (US); Daniel L. Martin, Knoxville, TN (US)

(21) Appl. No.: 13/086,418

(22) Filed: Apr. 14, 2011

Related U.S. Application Data
(60) Provisional application No. 61/374,014, filed on Aug. 16, 2010.

(51) Int. Cl. G09G 5/00

(52) U.S. Cl. 345/8

(57) ABSTRACT

A secure, comfortable, lightweight, and adjustable mounting platform to suspend miniature image displays in front a viewer's eyes without contacting the viewer's nose bridge, cheeks or ears. The mounting platform maintains airflow so as not to cause localized heating or fogging near the retained display devices. The mounting is to be flexible to allow the user to adjust the line of sight of the retained device along at least 4 degrees of freedom—lateral, elevation, depth and entering viewing angle for personal viewing preference, while being rigid enough to securely hold the imaging device when the user moves their head.

### CROSS-REFERENCE TO RELATED APPLICATIONS

This application claims the benefit of U.S. Provisional Application No. 61/374,014 filed Aug. 16, 2010.

### BACKGROUND

1. Field of Inventive Concept

The present general inventive concept relates generally to miniature image displays, and more particularly, to methods and apparatuses for supporting miniature image displays or corrective lenses without contacting the user's nose or ears while offering at least four (4) degrees of freedom adjustment.

2. Description of the Related Art

An apparatus for Head Mounted Displays (HMDs) have been used for many years in the field of virtual reality and miniaturized data display. One of the disadvantages of known support units is the amount of point pressure applied to areas of the user's nose bridge, ears, and/or temples when viewing miniaturized displays.

### BRIEF SUMMARY

The present general inventive concept relates generally to head mounted displays, and more particularly, to means by which the display and its supporting packaging can be comfortably and securely affixed to the user to provide multiple degrees of adjustability with respect to the user's eyesight without creating pressure on the nose bridge, ears, or temples. Additional features and embodiments of the present general inventive concept will be set forth in part in the description which follows and, in part, will be obvious from the description, or may be learned by practice of the general inventive concept.

Example embodiments of the present general inventive concept provide methods and apparatuses for suspending a miniature display in front of a viewer's eyes without contacting the nose, ears or cheeks in such a manner as to provide at least 4 degrees of freedom adjustment for viewing comfort while maintaining a rigid platform.

Some embodiments implement a headband worn around a viewer's head which is adapted to receive an angled mounting bracket attached to the headband by Velcro strips to support a commercially available imaging display or other viewing device. Alternative support methods to Velcro (such as tape, glue, magnets, statics, etc.) could be substituted. Alternatives to the bendable mounting bracket could also be used, such as angular adjustment hinges or other shape memory materials.

In some embodiments, a baseball cap can be substituted for the headband wherein the Velcro support material is provided underneath the bill of the cap to support the viewing device and to facilitate the at least 4 degrees of freedom adjustment.

Example embodiments can include a pair of monocular display units mounted to an adjustment bar or to the headband to provide inter-pupilary distance (IPD) adjustment between the display units.

Example embodiments of the present general inventive concept can also be achieved by providing a method of suspending a display unit in front of a viewer's eyes, including securing a mounting bracket to a head mounted article, and suspending the display unit from the mounting bracket to orient the display unit in front of the viewer's eyes when the head mounted article is worn by the viewer such that the display unit is provided with at least four degrees of freedom adjustment relative to the viewer's eyes without contacting the viewer's nose, ears or cheeks.

### BRIEF DESCRIPTION OF THE SEVERAL VIEWS OF THE DRAWINGS

These and other features and embodiments of the present general inventive concept will become more clearly understood from the following detailed description of the example embodiments read together with the accompanying drawings in which:

FIG. 1A to 1D illustrate headband mounted support systems for miniature displays or glasses that provide at least 4 degrees of freedom (DOF) of adjustment without contacting the user's nose, cheeks or ears, in accordance with exemplary embodiments of the present general inventive concept;

FIG. 2 illustrates the headband mounted system of FIG. 1A depicting at least 4 degrees of positioning freedom;

FIGS. 3A and 3B illustrate another example embodiment of the present general inventive concept;

FIG. 4A is a front view illustrating a pair of adjustable monocular display units and headband mounted support system in accordance with another example embodiment of the present general inventive concept;

FIG. 4B is a front view illustrating an adjustable binocular display unit and headband mounted support system in accordance with another example embodiment of the present general inventive concept; and

FIG. 5 is a perspective view of another example embodiment of the present general inventive concept.

### DETAILED DESCRIPTION

A wide variety of potential embodiments will be more readily understood through the description and illustration of certain exemplary embodiments. Additionally, the exemplary designs described and illustrated herein can provide the added benefit of open air transfer around the displays to improve the localized heat exchange and to eliminate fogging of the displays.

It is noted that in the accompanying drawings and illustrations, the sizes and relative sizes, shapes, and qualities of lines, entities, and regions may be exaggerated for clarity and/or convenience of illustration. It is also noted that throughout the following description, spatially relative terms, such as “up,” “down,” “right,” “left,” “beneath,” “below,” “lower,” “above,” “upper” and the like, may be used for ease of description to describe one element or feature's relationship to another element(s) or feature(s) as illustrated in the figures. It will be understood, however, that these spatially relative terms are intended to encompass different orientations of the device in use or operation in addition to the orientation depicted in the figures, and are provided for convenience of description only with reference to the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

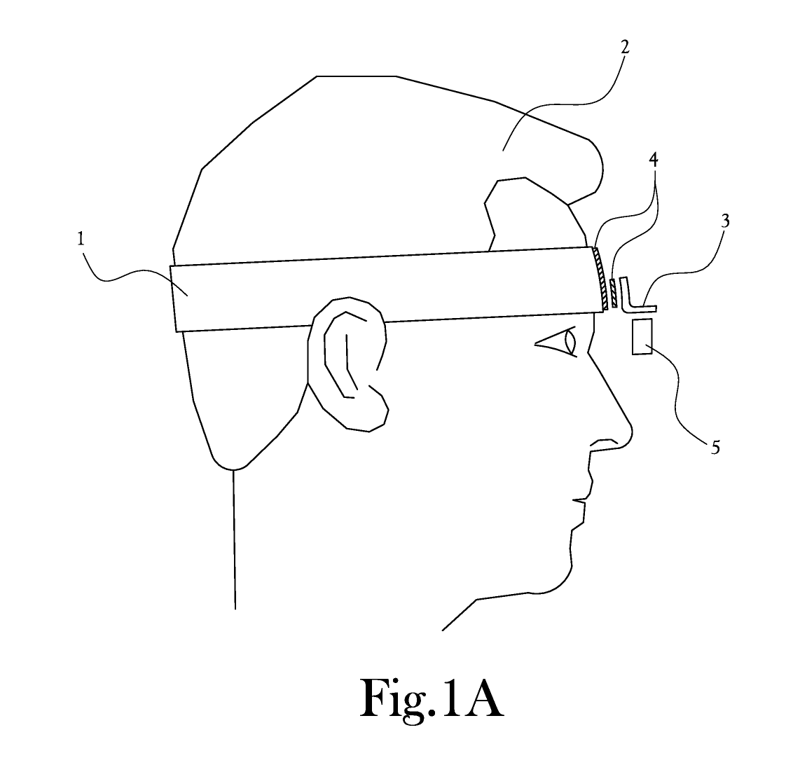

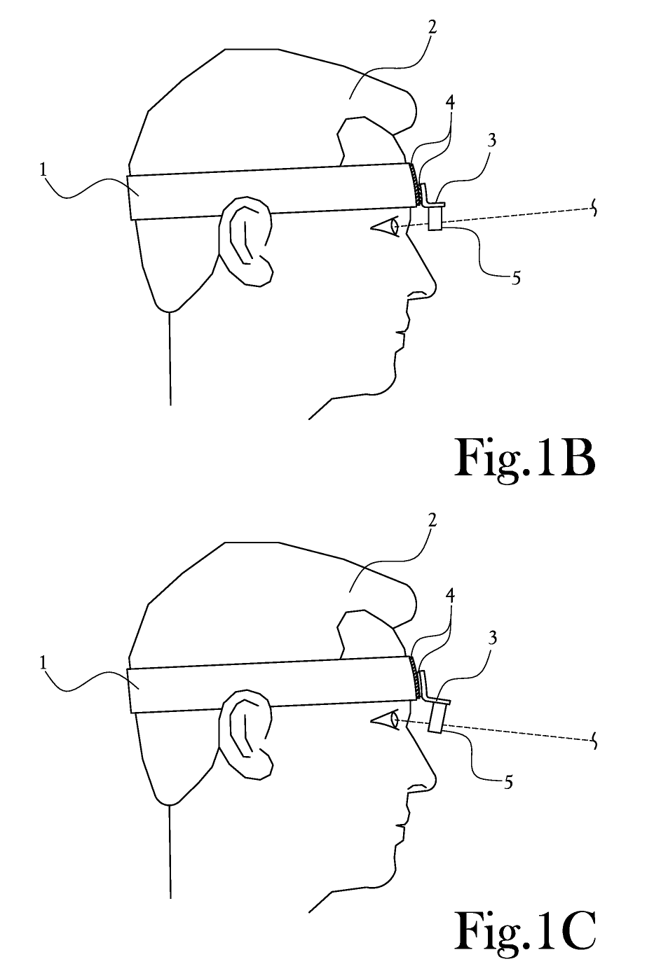

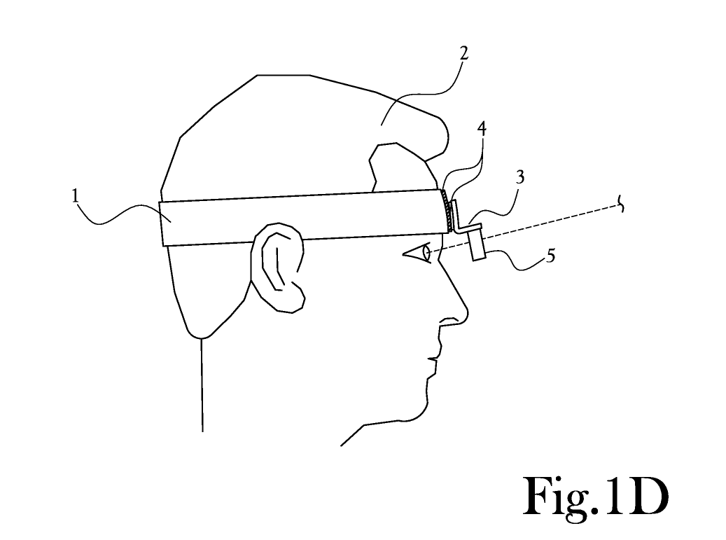

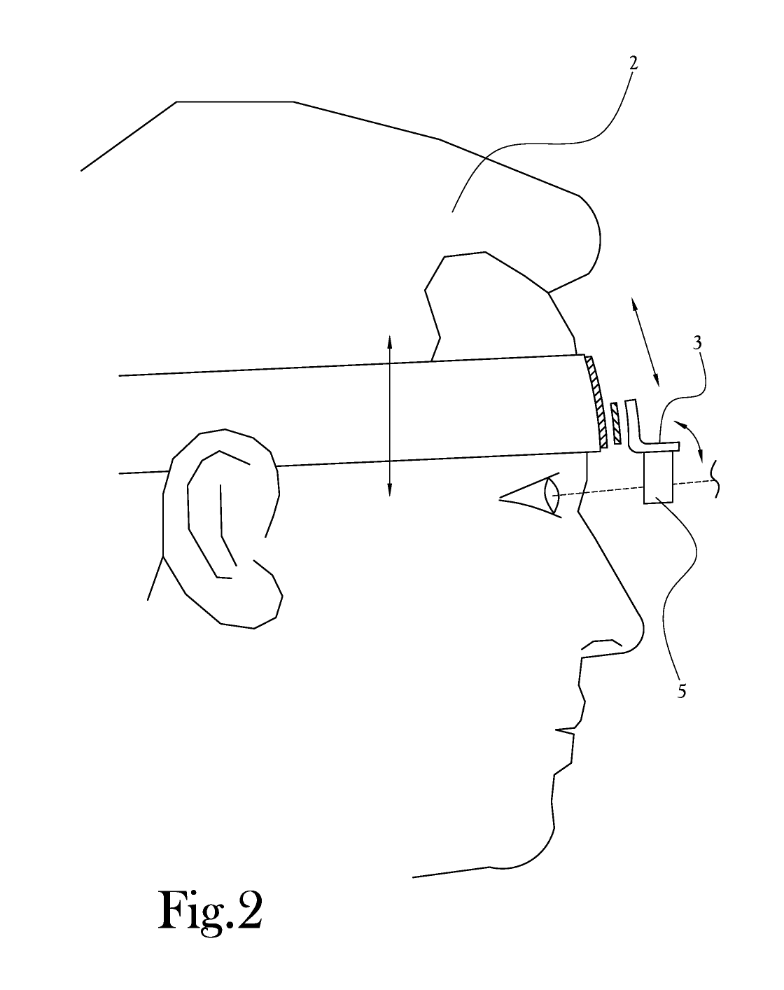

FIGS. 1A to 1D illustrate line drawings of exemplary designs that use a standard athletic headband 1 wrapped around a user's head 2, such as elastic terrycloth band, straps with a buckle, Velcro headband, bandana, and the like, to support an angled mounting bracket 3 attached to the headband by Velcro strips 4 to support a commercially available imaging display 5. The imaging display could be replaced by any number of different elements for eyewear purposes including, but not limited to, eyeglasses, binoculars, infrared imagers, etc. It is also possible to implement other known or later developed fastening means between headband and frame, in addition to Velcro, such as glues, tapes, magnets, statics, and the like, alone or in combination with one another.

A general concept of the example embodiments is to create a design that can retain the miniature displays rigidly relative to head movement in such a way as to offer positional and angular adjustment of the display relative to the users eyes in at least 4 dimensions (e.g., lateral, elevation, depth, and entering viewing angle). Ordinarily, users without the use of hand tools desire to easily and rapidly accomplish positional/orientational adjustments of the display unit to accommodate the ergonomic requirements of the broader user market. Also, for the sake of user comfort, the exemplary designs disclosed herein are configured to minimize weight, particularly on the nosebridge, and for simplicity of operation and design, the amount of moving parts are minimized for cost-effective manufacturing and assembly, while achieving multiple degrees of freedom for viewing adjustment.

The exemplary designs combine the lightweight, adjustable simplicity of a head sweatband (e.g., elastic headband, adjustable strap with a buckle, adjustable Velcro straps, etc.), or other head mounted support system such as a hat or any other type of head piece, with the adjustable rigidity of a Velcro-type mount to the imaging device frame and the incorporation of an angled bracket of connecting sheet metal or other bendable material, such as shape-memory material, to create a system that meets the objectives of the design.

FIG. 2 illustrates a possible arrangement how the attachment and reattachment of the Velcro interface can provide a variety of different adjustment positions, such as lateral and height adjustment, of the retained displays 5 without interference or support from the nose bridge. FIGS. 1B to 1D also illustrate that the angle of the mounting bracket 3 can be changed (bent) by the user to provide a variety of view entry angles and/or positions desired by a user. The present general inventive concept is not limited to a bending mounting bracket 3, and many other types of mounting and adjusting means may be provided without departing from the broader principles of the present general inventive concept. For example, in other example embodiments, it is possible to use a hinge and lock arrangement, in addition to, or in combination with, a bendable mounting bracket 3, to change the angle and position of the display 5 with respect to the viewer's eyes. Combinations of elevation and angle can also change the depth of the display from the eye because of the curvature of the forehead to accommodate viewing comfort.

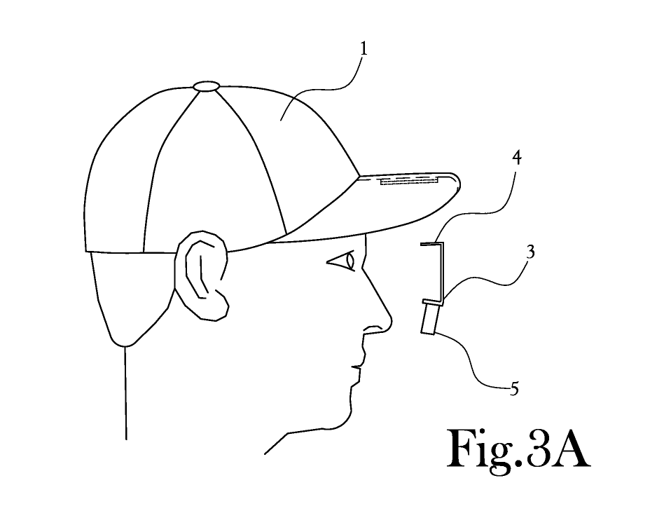

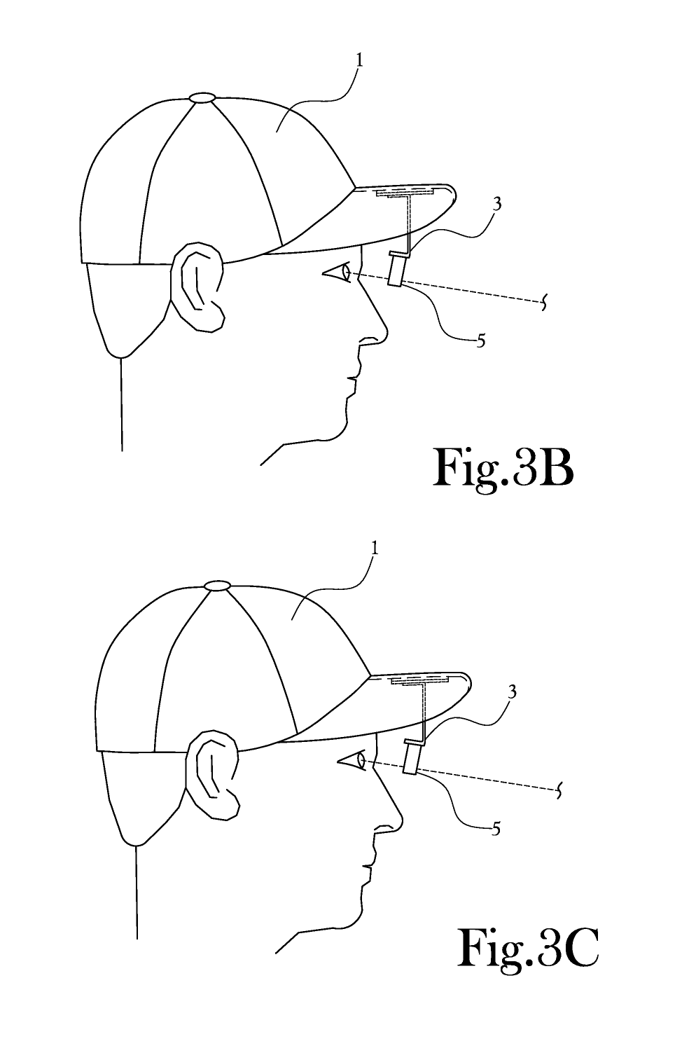

FIGS. 3A and 3B illustrate another example embodiment including a similar design to support and adjust a display 5 from a baseball cap for those that prefer to wear a cap rather than a headband. In this embodiment, it is possible to suspend the bracket 3 from the bill of the cap by attaching one side of the Velcro 4 to the underside bill of the cap 1 and the other side to the imaging mounting frame or bracket 3. This serves to secure the display 5 and provides for additional adjustment of depth from the user's eyes, as illustrated in FIGS. 1A to 1D.

Still other embodiments will become readily apparent to those skilled in this art from reading the above description in view of all the drawings. It is noted that the simplified diagrams do not illustrate all the various connections and assemblies of the various components, however, those skilled in the art will understand how to implement such connections and assemblies, based on the illustrated components, figures, and descriptions provided herein.

Another key factor in the comfortable operation of dual display mini-displays is the “inter-pupilary distance” (IPD) of the user. The techniques of the present general inventive concept can be used to hold and adjust monocular and/or binocular displays.

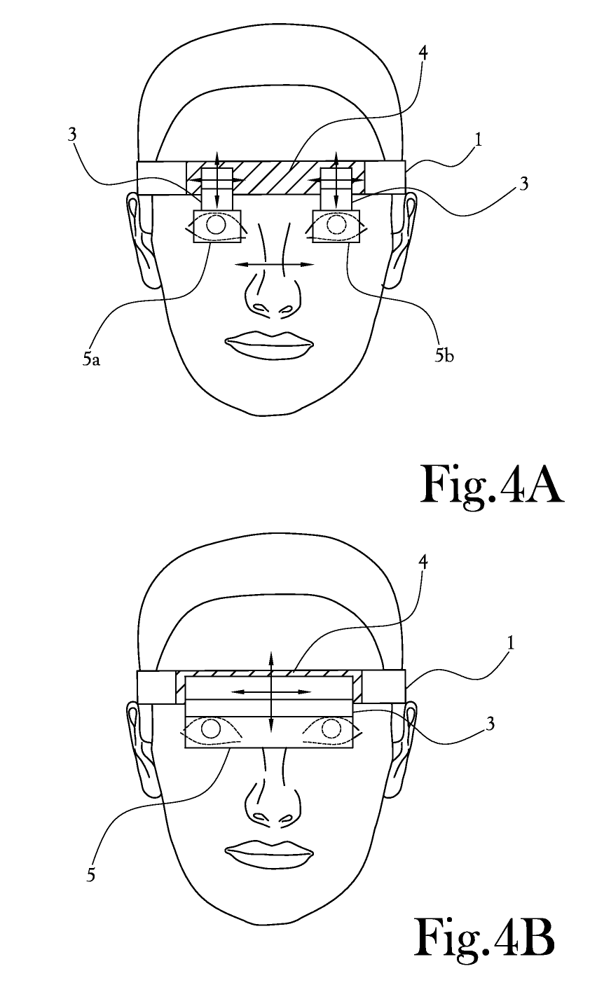

For example, as illustrated in FIG. 4A, it is possible to hold two monocular displays 5a, 5b with separate Velcro mounting 4 to provide IPD and additional elevation adjustment between each display, in addition to the other degrees of adjustment using a bendable bracket 3 similar to the above. As illustrated in FIG. 4B, it is also possible to hold a single binocular display 5 with Velcro mounting 4 and bendable bracket 3, using the techniques of the present general inventive concept. The binocular display 5 can include a built-in IPD adjustment available from the manufacturer, and also can be adjusted to provide multiple degrees of freedom as described above.

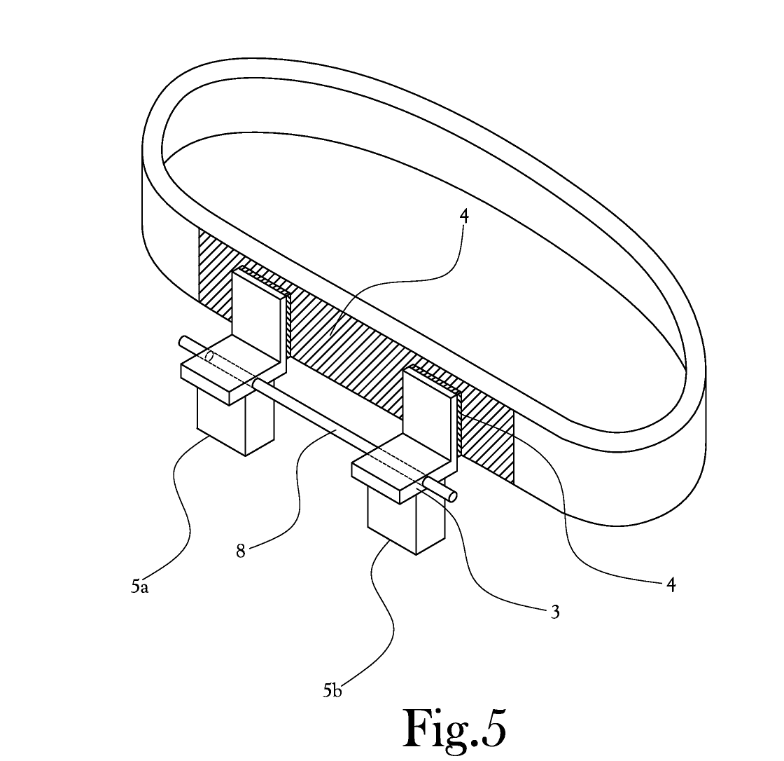

FIG. 5 is a perspective view of another example embodiment of the present general inventive concept. FIG. 5 illustrates an exemplary arrangement in which two monocular display units 5a, 5b are mounted on a slide bar 8, which in turn is mounted to a front surface of the headband using a bracket 3 and Velcro 4 arrangement, similar to the above. The display units 5a, 5b can be adapted to slide along the slide bar 8, using a suitable arrangement such as a worm gear or friction guide assembly, or other suitable arrangement chosen with sound engineering judgment to provide IPD adjustment between the individual display units 5a, 5b, in addition to the lateral, depth, and entering viewing angle adjustments for the aggregate assembly facilitated by the Velcro 4 and bendable bracket 3.

It is noted that numerous variations, modifications, and additional embodiments are possible, and accordingly, all such variations, modifications, and embodiments are to be regarded as being within the spirit and scope of the present general inventive concept. For example, the present general inventive concept can be adapted to receive signals from any number or various video/audio sources, and can communicate using any known or later developed wired or wireless technologies, such as Bluetooth. The exemplary head-mounted devices can be adapted to receive signals from a handheld control device to selectively operate a variety of audio/visual features of the display units. The exemplary devices can also include suitable connections to communicate signals to ear pieces and/or other audio/video accessories to enhance the audio/visual experience of the user.

Moreover, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Accordingly, while the present general inventive concept has been illustrated by description of several embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

What is claimed is:

1. An apparatus for suspending a display unit in front of a viewer's eyes, comprising:
a head mounted article disposed on the viewer's head;
a mounting bracket detachably mounted to the head mounted article; and
a display unit mounted to the angled mounting bracket to suspend the display unit in front of the viewer's eyes such that the display unit is provided with at least four degrees of freedom adjustment relative to the viewer's eyes.

2. The apparatus of claim 1, wherein the apparatus does not contact the viewer's nose, ears or cheeks.

3. The apparatus of claim 1, wherein the mounting bracket is detachably mounted to the head mounted article by velcro strips.

4. The apparatus of claim 1, wherein the head mounted article is a headband.

5. The apparatus of claim 1, wherein the head mounted article is a baseball-type cap.

6. The apparatus of claim 5, wherein velcro is provided underneath the bill of the cap to facilitate the at least 4 degrees of freedom adjustment.

7. The apparatus of claim 1, wherein the mounting bracket is detachably mounted to the head mounted article by at least one of tape, glue, magnets, and statics.

8. The apparatus of claim 1, wherein the mounting bracket comprises shape memory material.

9. The apparatus of claim 1, wherein the display unit comprises a pair of monocular display units mounted to an adjustment bar or to the head mounted article to provide inter-pupilary distance (IPD) adjustment between the display units.

10. A method of suspending a display unit in front of a viewer's eyes, comprising:
securing a mounting bracket to a head mounted article; and
suspending a display unit from the mounting bracket to orient the display unit in front of the viewer's eyes when the head mounted article is worn by the viewer such that the display unit is provided with at least four degrees of freedom adjustment relative to the viewer's eyes without contacting the viewer's nose, ears or cheeks.
